(19) United States
(12) Patent Application Publication
(10) Pub. No.: US 2010/0288902 A1
(43) Pub. Date: Nov. 18, 2010

(54) ROTATABLE SUPPORT CAPABLE OF ADJUSTING A TILTING ANGLE BY HANDLING A LINKING ROD THEREOF

(76) Inventor: Jan-Ban Liu, Taichung (TW)

Correspondence Address: Jan-Ban Liu, 235 Chung - Ho, Box 8-24, Taipei, 235, TW

(21) Appl. No.: 12/466,372

(22) Filed: May 14, 2009

(51) Int. Cl. F16M 13/00

(52) U.S. Cl. 248/349.1; 248/346.01

(57) ABSTRACT

A support for a notebook includes a main plate with a turn table arranged to a backside of the main plate and a supporting plate arranged to a top side thereof. A handle is formed to the main plate. A blowhole is formed to the supporting plate. A linking rod is arranged between the main plate and the supporting plate. Two turning rods are arranged to two ends of the linking rod. A positioning rod perpendicularly extends from each turning rod. Positioning hooks and retaining rings are formed to a backside of the supporting plate. The positioning hooks are supported by the turning rods so that the supporting plate will tilt from the main plate with certain angle. The turning rods can be moved to other positioning hooks so that angle of the supporting plate to the main plate will be changed.

### FIELD OF THE PRESENT INVENTION

The present invention relates to support, and particular to a rotatable support capable of adjusting a tilting angle by handling a linking rod thereof.

### BACKGROUND OF THE INVENTION

With the development of the technology, various notebooks are provided to customers. Notebooks have advantages of small size and mobility. However, notebooks are sometimes easily burned down because of heat generated from the notebook is hard to dissipate while a bottom of the notebook is attached to a surface of a table. While a screen of the notebook is opened, it is hard to move and turn the notebook. It is inconvenient and impractical especially in a demonstration. Therefore, the inventor develops the present invention based on experiences of related business to solve the disadvantages mentioned above.

### SUMMARY OF THE PRESENT INVENTION

Accordingly, the primary object of the present invention is to provide a support for a notebook easily to store, rotatable by a turntable, and also capable of increasing a tilting angle by pressing a turning rod.

To achieve above objects, the support for a notebook according to the present invention includes a main plate with a turn table arranged to a backside of the main plate and a supporting plate arranged to a top side thereof. A handle is formed to the main plate. A blowhole is formed to the supporting plate. A linking rod is arranged between the main plate and the supporting plate. Two turning rods are arranged to two ends of the linking rod. A positioning rod perpendicularly extends from each turning rod, and a turning sheet is formed to an end of each turning rod. Positioning hooks and retaining rings are formed to a backside of the supporting plate. Two axles are formed respectively to two corners of the supporting plate. The supporting plate is pivoted to the main plate by the axles of the supporting plate connected to buckling portion formed to the main plate. The retaining rings of the supporting plate are penetrated by the linking rod. The positioning hooks are supported by the turning rods, and the positioning rods are connected to buckling portions formed to the main plate so that the supporting plate will tilt from the main plate with certain angle. The turning rods can be moved to other positioning hooks by handling the turning sheet so that angle of the supporting plate to the main plate will be changed. The retaining rings of the supporting plate are penetrated by the linking rod. The turning rods will leave the positioning hooks and will be attached to the main plate by pressing the turning sheet close to the main plate while the supporting plate is raised so that the supporting plate and the main plate are closed together.

### BRIEF DESCRIPTION OF THE DRAWINGS

FIG. 1 is an exploded drawing of the present invention.

FIG. 2 is another exploded drawing of the present invention.

FIG. 3 is a schematic view showing an assembly of the present invention.

FIG. 4 is a schematic view showing a preferable embodiment of the present invention.

FIG. 5 is another schematic view showing a preferable embodiment of the present invention.

FIG. 6 is a schematic view showing another preferable embodiment of the present invention.

FIG. 7 is a schematic view showing one another preferable embodiment of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

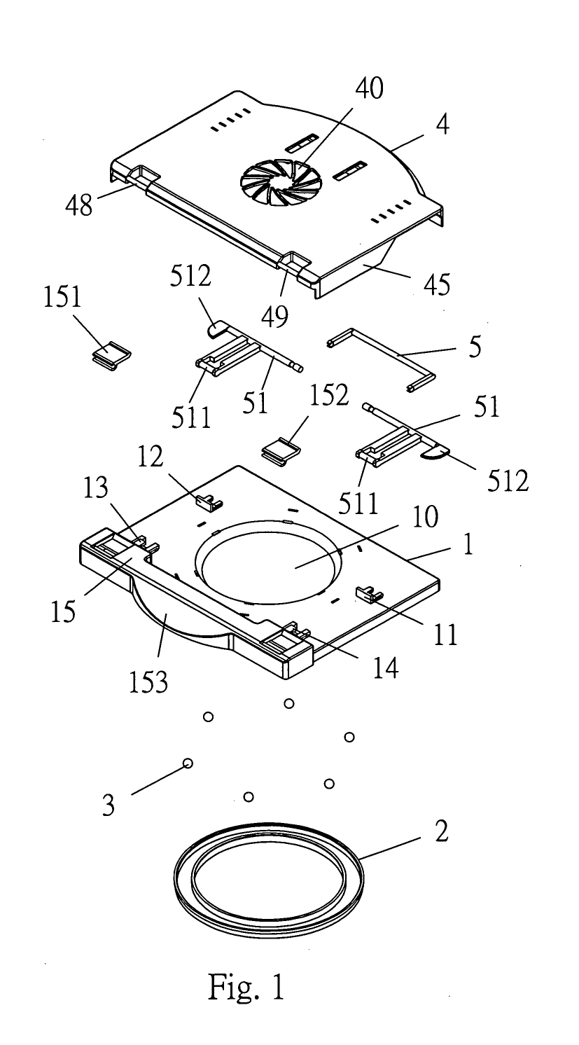

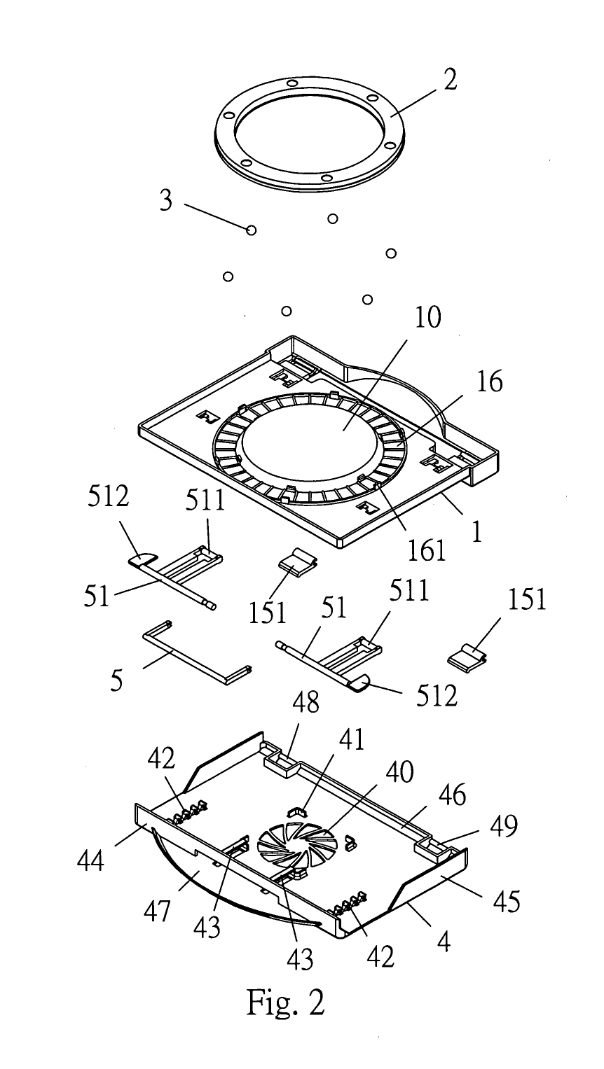

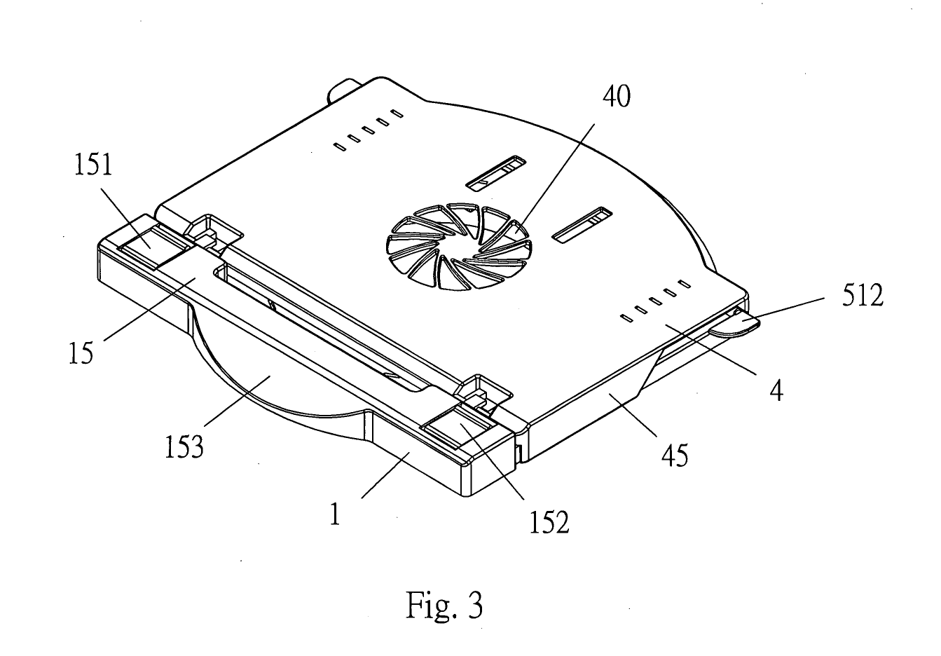

Referring to FIGS. 1, 2, and 3, a support for a notebook includes a main plate 1 with a through hole 10 on a center thereof. Buckling Portions 11, 12, 13, and 14 are formed around the through hole 10. A platform 15 protruding upwards from a longitudinal side of the main plate 1 has two stops 151 and 152 on two ends of the platform 15. A curved handle 153 is formed to an outer lateral side of the platform 15. On a backside of the main plate 1, a round recess 16 is formed along the through hole 10. Supporting units 161 are arranged along the recess 16 to support a turntable 2.

A plurality of balls 3 are arranged between the recess 16 and the turntable 2. A supporting plate 4 is installed above the main plate 1. A blowhole 40 is formed to a center of the supporting plate 4. Fixing columns 41 for a fan are formed to a backside of the supporting plate 4 near the blowhole 40. Two rows of positioning hooks 42 and two retaining rings 43 are formed on the backside of the supporting plate 4. Folded edges 44, 45, 46 and 47 are formed to four edges of the supporting plate 4. A curved plate 47 extends from the folded edge 44. Axles 48 and 49 are formed near the two ends of the folded edge 46. A linking rod 5 is formed between the main plate 1 and the supporting plate 4. Two turning rods 51 are arranged to two ends of the linking rod 5. A positioning rod 511 perpendicularly extends from each turning rod 51, and a turning sheet 512 is formed to an end of each turning rod 51.

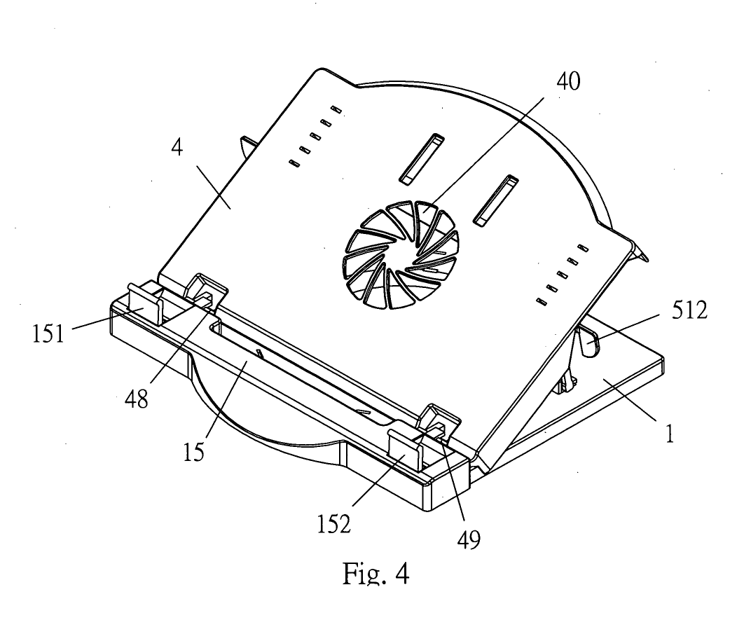

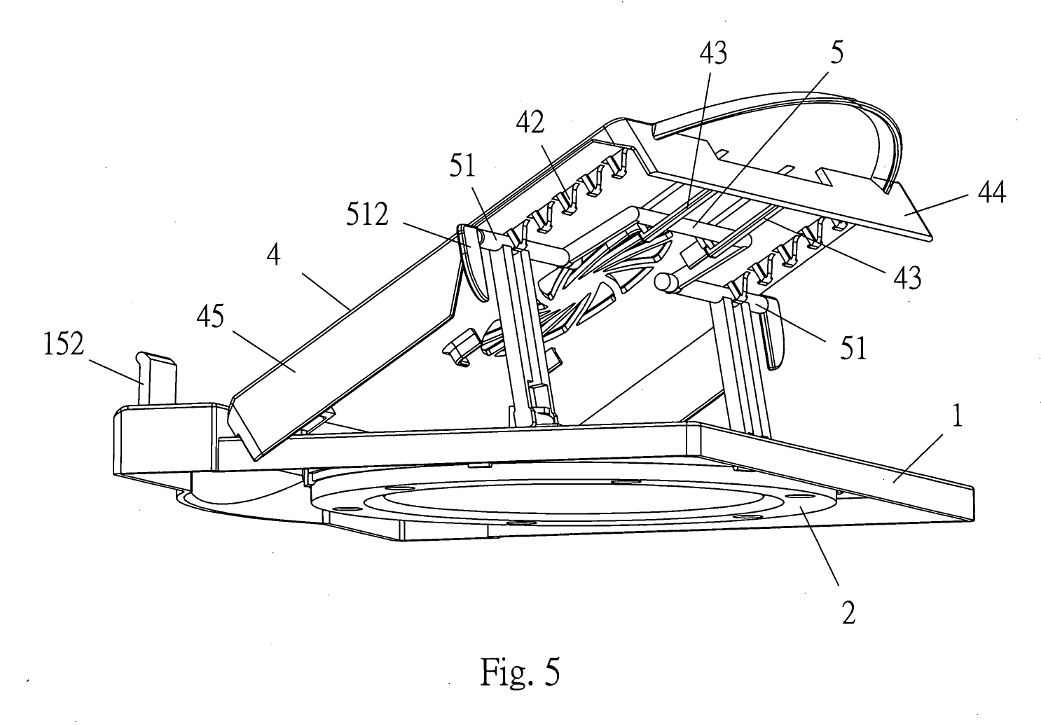

Referring to FIGS. 1, 4, and 5, the supporting plate 4 of the present invention is pivoted to the main plate 1 by the axles 48 and 49 of the supporting plate 4 being connected to the buckling portions 13 and 14 near the platform 15. The retaining rings 43 of the supporting plate 4 are penetrated by the linking rod 5. When the supporting plate 4 is raised, the turning rods 51 can be stuck to the positioning hooks 42 and the positioning rods 511 can be stuck to the buckling portions 11 and 12 respectively so that the supporting plate 4 will tilt from the main plate 1. The turning rods 51 can be moved to other positioning hooks 42 by handling the turning sheet 512 so that an angle of the supporting plate 4 to the main plate 1 will be changed. The stops 151 and 152 are movably installed to two corners of the platform 15 for holding a notebook.

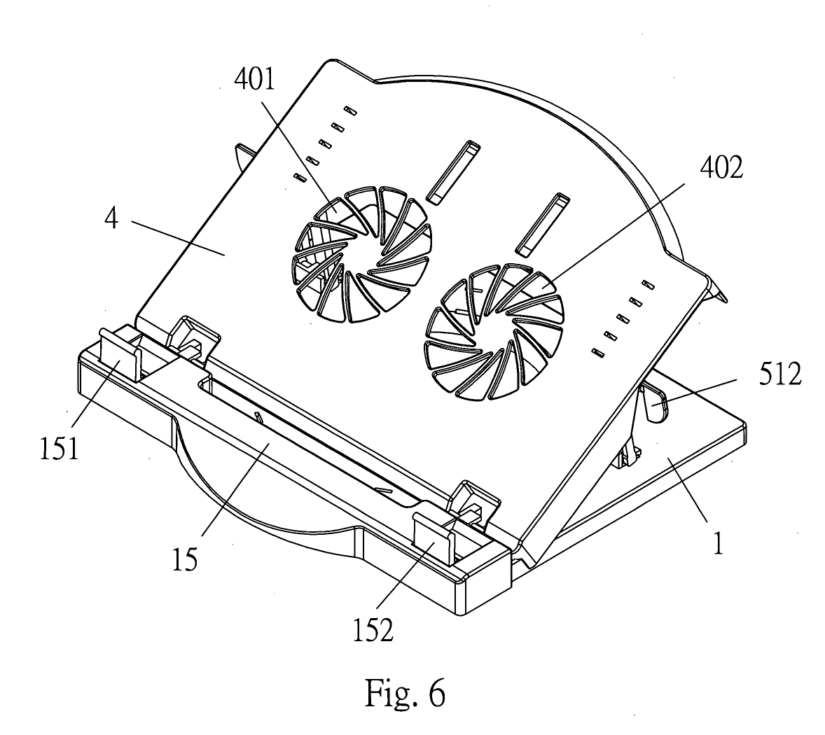

Referring to FIG. 6, two blowholes 401 and 402 are formed to the supporting plate 4 of the support for a notebook according to the present invention.

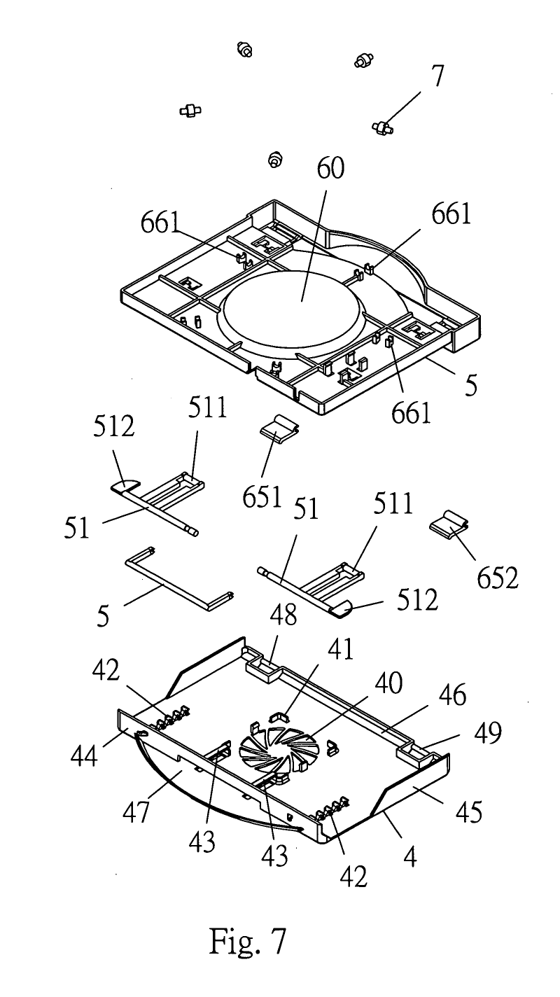

Referring to the FIG. 7, the support for a notebook according to the present invention includes a main plate 6 with a through hole 60 on a center thereof. Two stops 651 and 652 are installed to two corners of the main plate 6. On a backside of the main plate 6, a plurality of wheel frames 661 are arranged along the through hole 60 for receiving the wheels 7. A supporting plate 4 is installed to the main plate 6. A blowhole 40 is formed to a center of the supporting plate 4, fixing columns 41 for a fan are formed to a backside of the supporting plate 4 near the blowhole 40. Two rows of positioning hooks 42 and two retaining rings 43 are formed on the backside of the supporting plate 4. Folded edges 44, 45, 46 and 47 are formed to four edges of the supporting plate 4. A curved plate 47 extends from the folded edge 44. Axles 48 and 49 are formed near the two ends of the folded edge 46. A linking rod 5 is arranged between the main plate 1 and the supporting plate 4. Two turning rods 51 are arranged to two ends of the linking rod 5. A positioning rod 511 perpendicularly extends from each turning rod 51, and a turning sheet 512 is formed to an end of each turning rod 51.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A support for a notebook comprising a main plate with a through hole on a center thereof;
a supporting plate installed above the main plate;
a blowhole formed to a center of the supporting plate;
a linking rod arranged between the main plate and the supporting plate;
two turning rods being arranged to two ends of the linking rod;
a positioning rod perpendicularly extending from each turning rod, and a turning sheet being formed to an end of each turning rod;
two rows of positioning hooks and two retaining rings being formed to a backside of the supporting plate; two axles being formed to a folded edge of the supporting plate;
the supporting plate being pivoted to the main plate by the axles of the supporting plate being connected to buckling portions formed to the main plate;
the retaining rings of the supporting plate being penetrated by the linking rod;
wherein the turning rods will be stuck to the positioning hooks and the positioning rods will be stuck to the buckling portions so that the supporting plate will tilt from the main plate;
an angle of the supporting plate to the main plate will be changed by handling the turning sheet to move the turning rods to other positioning hooks;
two stops are movably installed on two corners of the main plate for holding a notebook;
the turning rods will leave the positioning hooks and will be attached to the main plate by pressing the turning sheet close to the main plate so that the supporting plate and the main plate are closed.

2. The support for a notebook as claimed in claim 1, wherein a round recess is formed along the through hole on a backside of the main plate, a plurality of supporting units are arranged to predetermined positions along the recess to support a turntable.

3. The support for a notebook as claimed in claim 1, wherein a plurality of balls are arranged between the recess and the turntable.

4. The support for a notebook as claimed in claim 1, wherein a plurality of fixing columns for a fan are formed to the backside of the supporting plate.

5. The support for a notebook as claimed in claim 1, wherein two blowholes are formed to the supporting plate.

6. The support for a notebook as claimed in claim 1, wherein a plurality of wheel frames are arranged to the backside of the main plate for receiving wheels.
